(19) United States
(12) Patent Application Publication
(10) Pub. No.: US 2024/0289395 A1
(43) Pub. Date: Aug. 29, 2024

(54) FACTUALITY OF GENERATED RESPONSES

(71) Applicant: Google LLC, Mountain View, CA (US)

(72) Inventors: Hao Zhou, Redwood City, CA (US); Shrestha Basu Mallick, San Francisco, CA (US); Trevor Strohman, Menlo Park, CA (US); Patricia Luisa Romero Domingo, Jackson Heights, NY (US); Amirhossein Kiani, San Francisco, CA (US); Yu Du, Sunnyvale, CA (US); Xinying Song, Kirkland, WA (US); Heng-Tze Cheng, Mountain View, CA (US); Quoc V. Le, Palo Alto, CA (US); Ed Huai-Hsin Chi, Palo Alto, CA (US); Christopher Jamie Maclean Hall, Tempe (AU)

(21) Appl. No.: 18/528,142

(22) Filed: Dec. 4, 2023

Related U.S. Application Data
(60) Provisional application No. 63/487,477, filed on Feb. 28, 2023.

(51) Int. Cl. G06F 16/9532; G06F 16/955; G06F 40/40

(52) U.S. Cl. CPC G06F 16/9532; G06F 16/955; G06F 40/40

(57) ABSTRACT

Implementations relate to helping a large language model generate factual responses to prompts that request factual content is disclosed. The large language model may receive a prompt context, a plurality of encoded context passages as input. The large language model is trained to determine whether or not to utilize the encoded context passages in generating the response. Implementations also relate to different methods of fine-tuning the responses generated by the large language model through query refinements, response re-writes, and evaluation of factual accuracy.

### RELATED APPLICATION

This application is a non-provisional of, and claims priority to, U.S. Provisional Application No. 63/487,477, filed Feb. 28, 2023, titled “Improving Factuality of Generated Responses,” the disclosure of which is incorporated herein by reference.

### BACKGROUND

Large language models (LLMs) are machine-learning models trained to generate a response (estimate the probability of a sequence of tokens, including words and/or emoji) in response to a prompt (an input). Such large language models have a high number of parameters (e.g., billions, hundreds of billions) and are commonly based on a transformer architecture. These models can generate realistic text or image responses to a prompt and can generate entirely new content, referred to as creative content.

### SUMMARY

Implementations relate to a system for training a generative large language model to produce factually-grounded answers with attribution to the source. The generated answers may include some level of creativity and can therefore answer open-ended prompts (such as “write a poem about x”) or prompts with no factual context (e.g., “hello”). The creativity can sometimes generate factually incorrect content. The factually incorrect generated content is referred to as a hallucination. Implementations relate to systems to reduce hallucinations while still allowing for creativity in the generated response. The system may include a large language model that not only takes a conversation context (or prompt context) as input, but also identifies a query/queries for the conversation context, obtains search results for the query/queries from a search engine, and provides the conversation context and the search results to the model as input. The model is further trained, or refined, via fine tuning techniques to learn when to use the search results in generating a response. The model can also be trained, via fine tuning techniques, to determine which of the provided search results to use. Learning when to rely on provided search results discourages hallucinations of factual content in the responses. Learning which results to use further discourages hallucinations. Put another way, implementations disclose methods for discouraging generated content that recites a fact but where the fact is not supported by evidence. Implementations may also include various techniques to provide citations (attributions) to supporting resources for facts in the generated response.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram that illustrates an example system in which improved techniques described herein may be implemented.

FIG. 2 is a diagram that illustrates an example factually-grounded generative system, according to disclosed implementations.

FIG. 3 is a diagram that illustrates an example refinement system, according to disclosed implementations.

FIG. 4 is a diagram that illustrates an example method for providing factually-grounded generative responses, according to disclosed implementations.

FIG. 5 is a diagram that illustrates an example method for refining a generative model, according to disclosed implementations.

FIG. 6 is a diagram that illustrates an example method for refining a generative model, according to disclosed implementations.

FIG. 7 is a diagram that illustrates an example method for refining a generative model, according to disclosed implementations.

FIG. 8 is a diagram that illustrates an example of a distributed computer device that can be used to implement the described techniques.

### DETAILED DESCRIPTION

Implementations relate to a factually grounded conversation system that can respond to open-ended prompts, but is trained to discourage hallucinations (creative content that includes a fact that is not supported by evidence). In some implementations, the training may enable a response generator to learn when to rely on supporting resources and when not to. As an example, a prompt of ‘how are you’ does not require any fact grounding; a wholly creative response can be appropriate for such prompts. In contrast, “write a poem about the first moon landing” implies certain facts (e.g., the date of the moon landing, the astronauts involved, etc.) that should not be hallucinated. Supporting resources can be any documents (including databases) available to a search engine that support or corroborate a fact. Implementations may perform a search for every prompt, regardless of whether the prompt requires fact grounding. This encourages the model to learn when to rely on search results. but the fine tuning enables the model to know when to use the search results and which of the provided search results to use.

The factually grounded conversation system responds to a prompt (query) and uses supporting resources (evidence) to factually ground the response generated for the prompt. Unlike conventional large language models, the large language model of the present disclosure has two components. The two components are a query genitor and a response generator. The query generator helps identify the supporting resources. The query generator is trained to generate queries that have a high likelihood of capturing the intent of a prompt.

The query generator may use few-shot or zero-shot techniques for bootstrapping. Because query generation encourages evidence-supported creative responses, quality of the queries generated by the query generator is important. Implementations include techniques to fine-tune the query generator, which results in generated queries of higher quality. A technical effect of higher quality queries provided as input to the response generator is generated responses with fewer hallucinations, which improves the quality of the generated responses.

The system sends a generated query (or two generated queries—this can depend on question type) to a search engine. The search engine provides, for each query, relevant sections of supporting resources identified as responsive to the query. These can include only supporting resources with a minimum level of confidence (e.g., at least 85%, 90%, etc. confidence). In some implementations a specific number of supporting documents (e.g., top n search results for each query) may be used as input to the response generator (e.g., top 5, top 10). In some implementations, a most relevant section from a single supporting resource (URL) is used. In some implementations, the top two relevant sections from a single supporting resource are concatenated.

Unlike conventional large language models, the response generator takes two inputs; a prompt context (e.g., the current prompt, prior prompts, and generated responses (or portions thereof, if they exist)) and relevant sections from supporting resources (e.g., protos/snippets provided by a search engine—in text format). Through fine tuning, the response generator learns when to rely on the relevant sections as well as which relevant sections to rely upon. The fine tuning enables the response generator to provide higher quality, creative responses, the quality referring to a reduction in hallucinations in the generated responses. Thus, a technical problem solved by disclosed implementations relates to decreasing the frequency of hallucinations in generated responses that also include some level of creativity. Put another way, the

The accuracy score prediction engine is trained using passages from search engine results, manually scored by raters based on consensus with context passages from other search results.

A technical advantage of disclosed implementations is that, in contrast to the conventional large language models, the generated responses provided by the above-described improved system are of higher quality (e.g., more likely to be correct) because the response generator is provided potentially supporting evidence for a generated response, which the generator learns when to rely upon. Moreover, an improved quality of generated responses can result in fewer user prompts and accordingly reduced network data.

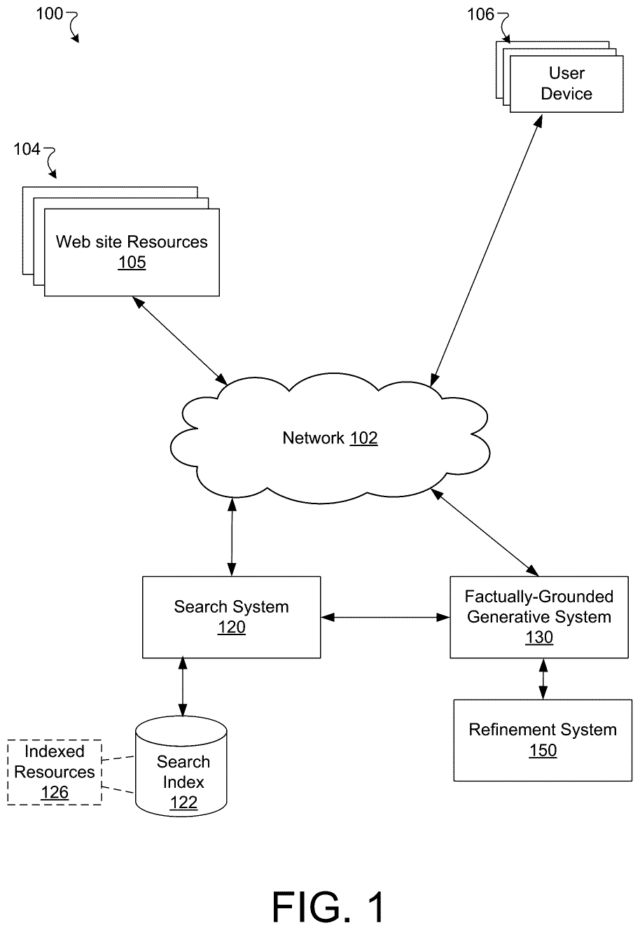

FIG. 1 depicts an example environment 100 in which users can interact with one or more factually-grounded large language models. In the example of FIG. 1, the factually-grounded large language model is supported by an Internet search engine. Implementations are not limited to Internet search engines but can be supported by other types of search engines that are also configured to provide resources responsive to a query. As used herein, resources can refer to any content accessible by an identifier by a search engine. Thus, resources include webpages, images, documents, media, etc.

With continued reference to FIG. 1, a search system 120 provides search services. The example environment 100 includes a network 102, e.g., a local area network (LAN), wide area network (WAN), the Internet, or a combination thereof, connects web sites 104, user devices 106, the factually-grounded generative system 130, and the search system 120. In some examples, the network 102 can be accessed over a wired and/or a wireless communications link. For example, mobile computing devices, such as smartphones can utilize a cellular network to access the network. The environment 100 may include millions of web sites 104 and user devices 106. In some implementations, the factually-grounded generative system 130 may be co-located with the search system 120. In other words, in some implementations the factually-grounded generative system 130 and the search system 120 may be operated at a same server, which may be a distributed server.

In some examples, a web site 104 is provided as one or more resources 105 associated with an identifier, such as domain name, and hosted by one or more servers. An example web site is a collection of web pages formatted in an appropriate machine-readable language, e.g., hypertext markup language (HTML), that can contain text, images, multimedia content, and programming elements, e.g., scripts. Each web site 104 is maintained by a publisher, e.g., an entity that manages and/or owns the web site. Web site resources 105 can be static or dynamic.

In some examples, a resource 105 is data provided over the network 102 and that is associated with a resource address, e.g., a uniform resource locator (URL). In some examples, resources 105 that can be provided by a web site 104 include web pages, word processing documents, and portable document format (PDF) documents, images, video, and feed sources, among other appropriate digital content. The resources 105 can include content, e.g., words, phrases, images and sounds and may include embedded information, e.g., meta information and hyperlinks, and/or embedded instructions, e.g., scripts.

In some examples, a user device 106 is an electronic device that is under control of a user and is capable of requesting and receiving resources 105 over the network 102. Example user devices 106 include personal computers, mobile computing devices, e.g., smartphones, wearable devices, and/or tablet computing devices that can send and receive data over the network 102. As used throughout this document, the term mobile computing device (“mobile device”) refers to a user device that is configured to communicate over a mobile communications network. A smartphone, e.g., a phone that is enabled to communicate over the Internet, is an example of a mobile device, as are wearables and other smart devices such as smart speakers. A user device 106 typically includes a user application, e.g., a web browser, to facilitate the sending and receiving of data over the network 102.

The user device 106 may include, among other things, a network interface one or more processing units, memory, and a display interface. The network interface can include, for example, Ethernet adaptors, Token Ring adaptors, and the like, for converting electronic and/or optical signals received from the network to electronic form for use by the user device 106. The set of processing units include one or more processing chips and/or assemblies. The memory includes both volatile memory (e.g., RAM) and non-volatile memory, such as one or more ROMs, disk drives, solid state drives, and the like. The set of processing units and the memory together form controlling circuitry, which is configured and arranged to carry out various methods and functions as described herein. The display interface is configured to provide data to a display device for rendering and display to a user.

In some examples, to facilitate searching of resources 105, the search system 120 identifies the resources 105 by crawling and indexing the resources 105 provided on web sites 104. Data about the resources 105 can be indexed. The indexed and, optionally, cached copies of the resources 105 are stored in a search index 122, e.g., as indexed resources 126.

The user devices 106 submit search queries to the search system 120. In some examples, a user device 106 can include one or more input modalities. Example input modalities can include a keyboard, a touchscreen, a mouse, a stylus, and/or a microphone. For example, a user can use a keyboard and/or touchscreen to type in a search query. As another example, a user can speak a search query, the user speech being captured through the microphone, and processed through speech recognition to provide the search query.

In response to receiving a search query, the search system 120 processes the query and accesses the search index 122 to identify resources 105 that are relevant to the search query, e.g., have at least a minimum specified relevance score for the search query. The search system 120 identifies the resources 105, generates a search result page. a search result page is generated by the search system 120 in response to a query. The search result page includes search results and can include other content, such as ads, knowledge panels, short answers, other types of rich results, links to limit the search to a particular resource type (e.g., images, travel, shopping, news, videos, etc.), other suggested searches, etc. Each search result corresponds to a resource available via a network, e.g., via a URL/URI/etc. The resources were determined to be responsive to the query by the search engine. The search result includes a link to a corresponding resource. Put another way, each search result represents/is associated with a resource. The search result can include additional information, such as a title, a portion of text obtained from the content of the resource (e.g., a snippet), an image associated with the resource, etc., or other information relevant to the resource and/or the query, as determined by the search engine of the search system 120. The search system 120 may include a component configured to format the search result page for display on a user device 106. The search system 120 returns the search result page to the query requestor. For a query submitted by a user device 106, the search result page is returned to the user device 106 for display, e.g., within a browser, on the user device 106.

In disclosed implementations, the factually-grounded generative system 130 may also send a query to the search system 120. The factually-grounded generative system 130 may use an application programming interface (API) of the search engine of the search system 120. The search engine API may return search results in a way that is not formatted for display, but instead enables the factually-grounded generative system 130 to read, analyze, and further process the information in a search result (e.g., the resource address, the relevant text extracted from the content, the title, etc.). In addition, the search engine API may enable the factually-grounded generative system 130 to request properties of the returned search results, e.g., a particular number of search results, a particular minimum relevancy of search results, etc., for a query.

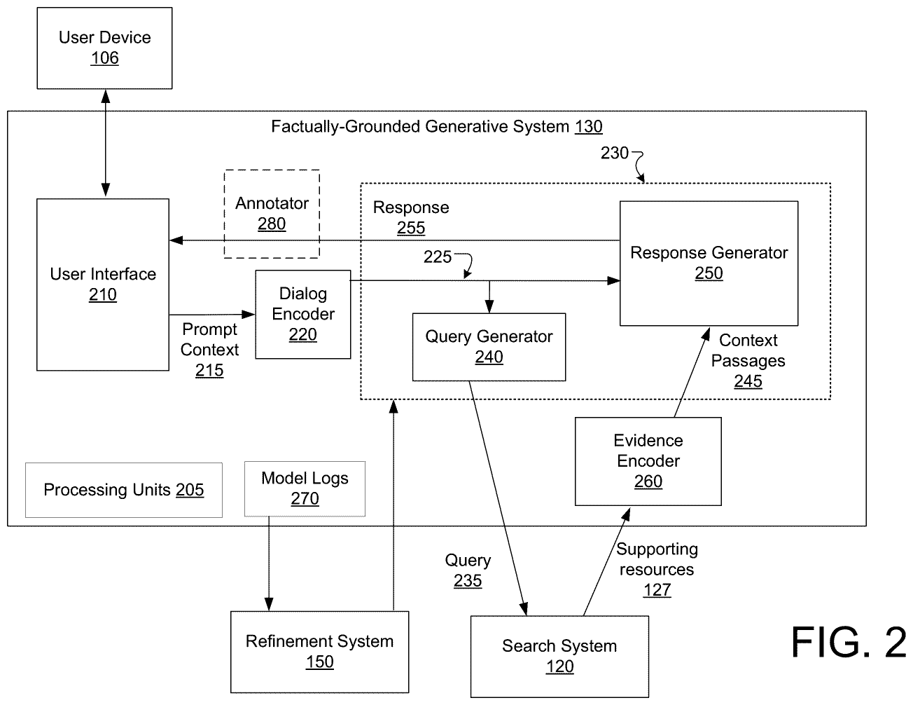

In accordance with implementations of the present disclosure, the example environment 100 also includes factually-grounded generative system 130 communicably coupled to the search system 120, e.g., directly coupled or coupled over a network such as network 102. The factually-grounded generative system 130 may also be communicably coupled to web site 104 and/or user device 106. The factually-grounded generative system 130, which includes a large language model and is described in more detail with respect to FIG. 2. The environment 100 also includes a refinement system 150. The refinement system 150 generates training data for refining, or fine-tuning, the large language model of factually-grounded generative system 130.

FIG. 2 is a diagram that illustrates an example factually-grounded generative system 130, according to disclosed implementations. The factually-grounded generative system 130 is configured to generate responses to prompts. A prompt can be any input received from a user of the user device 106, e.g., via user interface 210. One or more of the components of the factually-grounded generative system 130 can be, or can include processors (e.g., processing units 205) configured to process instructions stored in a memory. Examples of such instructions as depicted in FIG. 2 include the user interface 210, the dialog encoder 220, the evidence encoder 260, and a large language model 230.

The user interface 210 is configured to receive prompts from the user device 106. In some implementations, user interface 210 receives the prompts over a network interface, i.e., over a network. The user interface 210 can be configured to display a prompt input area. The prompt input area may take text as input. The prompt input area may take images as input. The prompt input area may take media (audio/video) files as input. The user interface 210 may also be configured to display the response 255 to a prompt. In some implementations, the user interface 210 may be part of (included in) another user interface. For example, the user interface 210 can be part of a search engine user interface, a browser tool or extension, a document extension or add in, etc.

The user interface 210 may be configured to display a conversation. The user interface 210 may be configured to display a portion of a conversation. A conversation includes the prompts and responses (prompt rounds) associated with a session. A session can be defined by a user. For example, the user interface 210 may include a control that enables the user to expressly start a new session, and thus a new conversation. A session can be defined by a predetermined number of prompt rounds (a round being a prompt and its corresponding response). In such an implementation, a new session (and thus a new conversation) may begin after the predetermined number of prompt rounds. A session can be defined by a tab or window. For example, a session may encompass all prompt rounds occurring within the browser tab in which the user interface 210 is presented. In some implementations, the factually-grounded generative system 130 can expressly end a session based on some criteria (e.g., based on a topic or other characteristic of a prompt, number of prompt rounds, etc.). An indication of the new session may be included in a final response 255 for an ending session. A conversation is part of a prompt context 215. A prompt context 215 can thus include a current prompt and the prior prompt rounds. If no prior prompt rounds exist, the prompt context may include the current prompt. In some implementations, the prompt context 215 can include metadata. The metadata can include a number of prior prompt rounds. The metadata can include, with user permission, information about content displayed on a display of the user device 106. The metadata can include a topic and/or entity determined from the content displayed on the display. The metadata may include any information about the user device 106 and/or user preferences (with user permission) relevant to the prompt.

The user interface 210 may be configured to receive a prompt context 215 from the user device 106. For example, the user may initiate sending the prompt context 215 by submitting a current prompt to the user interface 210. The factually-grounded generative system 130 may include dialog encoder 220. The dialog encoder 220 is configured to generate encoded dialog 225. The dialog encoder 220 may de-normalize the current prompt of the prompt context 215 in generating the encoded dialog 225. De-normalizing the current prompt replaces references to entities outside of the prompt with the entity. The reference could be to an entity mentioned in a prior prompt or prior response of the prompt context 215 (e.g., a prompt or response from a prior round). The reference could be to an entity in the metadata. For example, a prior prompt may be “Show me restaurants in Portland” and a current prompt may be “No, I mean Maine.” The dialog encoder 220 may be configured to change the current prompt to “show me restaurants in Portland Maine.” Likewise, if the current prompt is “show me restaurants in Portland” the dialog encoder 220 may be configured to disambiguate Portland based on metadata in the prompt context 215, e.g., an approximate location, a topic in the metadata, identification of an entity in the metadata (e.g., Acadia National Park or Mt. Hood), etc. The dialog encoder 220 may also use prior prompt rounds for disambiguation. For example, “show me restaurants in Portland” may be disambiguated based on a prior response that mentions the Columbia River. In some implementations, the dialog encoder 220 may also vectorize the denormalized prompt context, i.e., convert the denormalized prompt context to vectors of real numbers (feature vectors). Thus, the encoded dialog 225 can be feature vectors used as input for the large language model 230. In some implementations, the large language model 230 may vectorize the encoded dialog 225 (the denormalized prompt context).

The large language model 230 is an example of a large language model. The large language model 230 is trained to generate conversational responses to prompts (e.g., response 255) that have some level of creativity. A response has some level of creativity when the response is not copied from a source and is conversational in nature. This makes the response 255 different from search results obtained in response to a search query. Search results include relevant text (snippets) taken directly from a source. Some search result pages include short answers. The short answers are conventionally taken from a search result or from an API of a service (e.g., such as weather data from weather.com). Some search result pages include a knowledge panel, with information taken from an entity repository, such as a knowledge graph. In each of these cases the information is traceable to a resource and not altered or only slightly altered. In contrast, the response 255 is not credited directly to any source (reference) because the response is synthesized by the large language model 230. Although not credited directly to any reference, factual information contained in the response 255 may be supported by one or more references. The large language model 230 can provide responses for open-ended prompts, such as “write a poem about x” or “do you have an opinion on ice cream?”. Such prompts require a high level of creativity. The large language model 230 can also generate responses for complex questions (e.g., “what causes poverty?”), opinion questions (“is baseball better than basketball?”), etc. These responses may have a high level of creativity while including statements that can be verified (i.e., factual statements). Because a large language model, such as large language model 230, generates responses with some level of creativity, the responses can include factual information that is incorrect. Such statements (incorrect factual information) is referred to as a hallucination. Implementations help train/refine the large language model 230 to generate fewer hallucinations.

To help the large language model 230 generate fewer hallucinations, the large language model 230 may include two portions: a query generator 240 (a query generating portion) and a response generator 250 (response generating portion). The query generator 240 may be a model (or layers of the large language model 230) that predicts a query (or multiple queries) given the encoded dialog 225. The query generator 240 may be fine-tuned using techniques described herein. The query generator 240 may be configured to generate a query 235 for every encoded dialog 225. Put another way, the query generator 240 may not try to determine whether or not the current prompt is a factual prompt, requests a particular fact, fits a certain category, etc. By generating a query 235 for every prompt the response generator 250 can learn when to rely on the context passages 245 in generating a response 255.

The query generator 240 may be configured to send the query 235 to a search system 120. In some implementations, the query generator 240 may use an API of the search system 120. In some implementations, the query generator 240 may request at most a predetermined number of top-ranked search results for the query 235. In some implementations, the query generator 240 may request that search results returned have a minimum relevancy score (e.g., 80% relevance, 90% relevance). In some implementations, the query generator 240 may request a category of references be excluded from the search results. For example, the query generator 240 may request that resources deemed to relate to adult content be excluded. As another example, the query generator 240 may request that resources tied to a specific domain (e.g., a particular news website) be excluded. As another example, the query generator 240 may request that resources representing personal profiles (e.g., public tax records, public social media profiles) be excluded.

The search system 120 provides a search result for the query 235. In the context of the factually-grounded generative system 130, the search results may be referred to as supporting resources 127. For example, the API of the search system 120 may return a data structure that includes, among other things, an identifier for a supporting resource and a portion of relevant content extracted from the supporting resource. Thus, supporting resources 127 can include an identifier (e.g., URL/URI) of each supporting resource and relevant content (e.g., text, and image, etc.) for the supporting resource. The relevant content for a supporting resource that is returned from the search system 120 may have a size limit, e.g., a maximum size of 300 characters, 500 characters. For ease of discussion, the relevant content provided by the search system 120 API is referred to as short content. In some implementations, the supporting resources 127 can include content from an entity repository (e.g., content from a knowledge graph) that is responsive to the query 235. In some implementations, content from a short answer (e.g., onebox), is provided as part of the supporting resources 127. The entity repository and/or short answer content may not be associated with a resource identifier, but may be considered supporting resources. In some implementations, these search results are processed by an evidence encoder 260 into a format appropriate for the response generator 250 and provided as context passages 245 to the response generator 250 with the encoded dialog 225.

In some implementations, the evidence encoder 260 may be further configured to enhance the relevant content (short content) of the supporting resources 127 as part of converting them into the context passages 245. In some implementations, the evidence encoder 260 may expand the maximum size of the relevant content, e.g., to 1000 characters. The expanded characters can be taken from content occurring before the short content in the resource. The expanded characters can be taken from content occurring after the short content in the resource. The expanded characters can be taken from content surrounding the short content in the resource. In some implementations, the evidence encoder 260 may call a service of the search system 120 to provide the expanded characters. In such implementations, the evidence encoder 260 may provide the service with the resource identifier and the query and may request one (or two) top relevant portions of each resource. In some implementations the maximum size of a relevant portion may also be provided to the service as a parameter. The expanded relevant sections may be longer than the short content but shorter than a large maximum number of characters (e.g., 2000 characters) may tend to include boilerplate, which is not as helpful in refining the evidence encoder 260 to generate factually-grounded responses. The expanded relevant sections may be referred to as medium length content. The expanded relevant sections may be at least double in size (character count) than the short content.

In some implementations, the evidence encoder 260 may obtain a second portion of relevant content from the resource. For example, the evidence encoder 260 may obtain the top two (or three, or more) relevant portions of a supporting resource. In some implementations, the evidence encoder 260 may be configured to determine the top two relevant portions. In some implementations, the evidence encoder 260 may be configured to request the top two relevant portions from a service of the search system 120. The service of the search system 120 and/or the evidence encoder 260 may use the query 235 used to generate the supporting resources 127 to determine the top two relevant portions. In some implementations, the evidence encoder 260 may enhance the relevant sections by obtaining two (or more) relevant sections that are expanded (e.g., to 1000 characters). Using longer (expanded) relevant portions is one method of refining the response generator 250 to generate factually-grounded responses. Using multiple (2, 3, or more) relevant portions is another method of refining the response generator 250 to generate factually-grounded responses. Using two medium-length relevant content portions may provide better context for the response generator 250 than one long relevant content portion, which leads to decreased hallucinations in generated responses.

In some implementations, the evidence encoder 260 may reverse the relevance order of the supporting resources. For example, a supporting resource ranked as most relevant may have its corresponding relevant content at the end of the context passages 245. In some implementations, the evidence encoder 260 may remove non-relevant data from the supporting resources 127. The non-relevant data can be any non-text data. For example, the supporting resources 127 may include markup (e.g., XML markup, HTML markup) that helps identify the different fields and field values and/or helps a browser display the supporting resources 127 as a search result page. The markup may be removed from the supporting resources 127 by the evidence encoder 260. The evidence encoder 260 may concatenate the text of the portions of relevant content for the supporting resources. In other words, the evidence encoder 260 may concatenate the relevant content (e.g., short length content or medium length content) for the supporting resources together as one large block of text. This large block of text can be the context passages 245. In some implementations, the evidence encoder 260 may vectorize the large block of text and provide the vectorized text as context passages 245. Context passages 245 represent relevant content passages from at least some of the supporting resources 127 that have been processed for input into the response generator 250. Although discussed as generating a query, the query generator 240 may generate more than one query for a prompt context and submit more than one query to the search system 120. In such implementations, the factually-grounded generative system 130 may include supporting resources 127 for more than one query in the context passages 245. The response generator 250 may have a similar architecture as other large language models (e.g., GLaM, LaMDA, PaLM, GPT-3, and chatGPT). The response generator 250 is capable of generating responses with high creativity, for example in response to open-ended prompts (e.g., “give me five first date ideas”) and prompts that lack any factual context (e.g., “how do you feel?”). The response generator 250 generates responses to factual questions informed by the context passages 245 from search queries that are generated before response generation (e.g., by the query generator 240), by “memorized” facts that are learned from the training data, and by potential hallucinations that might be related to the conversation context or the stochasticity of the generation process. The response generator 250 can also generate responses with one or more factual statements. To help reduce hallucinations, the response generator 250 takes not only the encoded dialog 225 as input, but also context passages 245. The context passages 245 represent relevant text from supporting resources determined to be relevant to the query 235. The response generator 250 is further trained (refined, or fine-tuned) to learn when and how to use the context passages 245 in generating a response 255 to a prompt context 215. The further training may be accomplished using the refinement system 150 as described herein.

In some implementations, the factually-grounded generative system 130 may include a corroborator 280. The corroborator 280 may be configured to add information to the response that enables the user to check/corroborate the response 255 generated by the response generator 250. In some implementations, the corroborator 280 may determine that the prompt relates to a fact; and provide the query 235 (or queries) with the response 255 for presentation to the user via the user interface 210. In some implementations, the corroborator 280 may add a selectable control (e.g., a button, a link, an icon) that is configured to submit the query to a search engine (e.g., search system 120) in response to being selected. The query may be submitted in a new tab of the browser and the search results displayed in the new tab. In some implementations the new tab may be opened in a new browser instance (e.g., a new browser window). In some implementations, selection of the control may cause a side panel of the browser to open, and the query is submitted from the side panel and the search results displayed in the side panel. In some implementations, selection of the control may cause an overlay window or pop-up window to open, and the search results may be presented in the overlay or pop-up window.

In some implementations, the corroborator 280 may determine that a span of text in the generated response includes a fact. In response to determining the span of text includes a potential fact, the corroborator 280 may identify a corroborating resource that supports the potential fact. The corroborating resource may be one of the resources from supporting resources 127. The corroborating resource may be a response identified in response to the corroborator 280 submitting the span of text as a query to a search system 120. The span of text may have more than one corroborating resource. If a corroborating resource is identified, the corroborator 280 may alter an appearance of the span. For example, the span may be highlighted, underlined, bolded, have the text color altered, have a text style altered, etc. The corroborator 280 may also turn the text span into a hyperlink, where the hyperlink opens/navigates to the corroborating resource.

In some implementations, the corroborator 280 may insert an icon after the text span. The icon may be a favicon associated with the corroborating resource. In some implementations, the corroborator 280 may insert the favicon in response to determining that there is a single corroborating resource for the text span. In some implementations, the corroborator 280 may insert a favicon for each corroborating resource identified for the text span. A favicon is an icon associated with the domain (website) that hosts the resource. The corroborator 280 may make the favicon a selectable control that, when selected, is configured to navigate to the corroborating resource.

In some implementations, the corroborator 280 may insert a footnote after the text span. The footnote may be a number that is anchor text for a hyperlink to the corroborating resource. Thus, a user may select the footnote to navigate to the corroborating resource identified by the hyperlink.

In some implementations, the corroborator 280 may append a list of corroborating resources to the response. A resource in the list of corroborating resources may be presented in a resource summary. The resource summary may include an image from the corroborating resource. The resource summary may include a favicon of the resource. The resource summary may include a title from the corroborating resource. A resource summary may include a small portion of content (e.g., 300 characters or less) from the corroborating resource. The resource summary may be selectable and configured to, when selected, navigate to the corroborating resource. The corroborator 280 may generate a resource summary for each corroborating resource identified for the response. The corroborator 280 may arrange multiple resources summaries in a scrollable carousel presented with the response in the user interface presented to the user. The corroborator 280 can arrange multiple resources summaries in a grid with the response in the user interface.

In some implementations, the corroborator 280 may provide query suggestions that may help a user corroborate the response. For example, for each span of text that includes a potential fact the corroborator 280 may submit the span of text to the query generator 240. The corroborator 280 may include the query generated by the query generator 240 as a suggested query provided with (displayed with) the response. The suggested query can also be selectable and, when selected by the user, may send the query to a search system, which provides a search result page for the query.

In some implementations, the factually-grounded generative system 130 may generate model logs 270. Model logs 270 includes log records that capture a conversation. A conversation record includes at least a prompt context 215 and the response 255 generated for the prompt context 215. Some conversation records in the model logs 270 may also capture the query 235 generated for the prompt context 215. Some conversation records in the model logs 270 may also capture the supporting resources 127 and/or the context passages 245 generated for the query 235. The model logs 270 may be used by a refinement system 150 to generate training data used by the factually-grounded generative system 130 to further refine (fine-tune, train) the large language model 230.

In some implementations, the user interface 210 may include a factuality reporting control. The factuality reporting control may enable a user of the user device 106 to mark a particular response as including a hallucination (an incorrect fact). In some implementations, in response to selection of the factuality reporting control the factually-grounded generative system 130 may add a conversation record to the model logs 270 with an indication that the generated response for the conversation record includes an incorrect fact. Such conversation records in the model logs 270 may be used by the refinement system 150 to identify seed conversations. In some implementations, in response to selection of the factuality reporting control the factually-grounded generative system 130 may prompt the user to provide an alternative fact and/or to rewrite the response. In some implementations, the user interface 210 may be configured to receive a location of a resource corroborating the fact (e.g., a URL/URI of the resource). The factually-grounded generative system 130 may add a conversation record to the model logs 270 that captures this user-provided information. This information can be used, e.g., by refinement system 150 or by another system to generate training data to further refine the large language model 230.

In some implementations, the user interface 210 may be configured to use reinforcement learning from human feedback to help train the response generator 250. In such an implementation, the response generator 250 may provide two responses 255 to the same input and the user interface 210 may be configured to present both responses to the user with a user interface element that lets the user provide an indication of which response is more accurate. The indication (of which of the two responses the user indicated as more accurate) can be provided to the response generator 250, which can be optimized towards the accurate response. In some implementations, the indication may be included in the model logs 270.

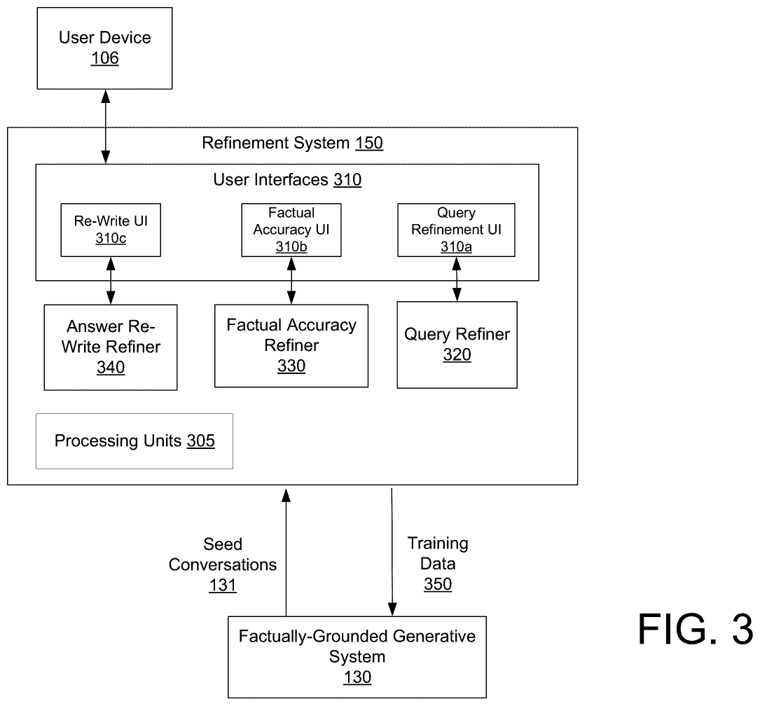

FIG. 3 is a diagram that illustrates an example refinement system 150, according to disclosed implementations. The refinement system 150 is configured to generate training data 350 used to further train (refine) the query generator 240 and/or the response generator 250 of the large language model 230. The training data can include labeled training examples to assist with various training techniques, such as few-shot training. One or more of the components of the refinement system 150 can be, or can include processors (e.g., processing units 305) configured to process instructions stored in a memory. Examples of such instructions as depicted in FIG. 3 include the user interfaces 310, the answer re-write refiner 340, the factual accuracy refiner 330, and the query refiner 320. In some implementations, the refinement system 150 may be in communication with the factually-grounded generative system 130. In some implementations, the refinement system 150 can be in communication with the search system 120. In some implementations, the refinement system 150 and the factually-grounded generative system 130 can be hosted on the same server, the same distributed computing system, etc. In some implementations, the refinement system 150 can be hosted on the same system (server, distributed computing system, etc.) as the search system 120.

The query refiner 320 may be configured to generate training examples to refine the query generator 240 portion of the large language model 230. The query refiner 320 may be configured to use the model logs 270 to identify seed conversations 131. Seed conversations 131 may be conversation records from the model logs 270 that meet some criteria. The criteria may be a time period (e.g., conversation records from the model logs 270 that were recorded during a given time period). The criteria may be a characteristic of the prompt (e.g., conversation records that include a simple question prompt, conversation records that include an open-question prompt, conversation records that include a prompt that matches a template, conversation records that include a prompt that mention an entity, etc.). The criteria may be a characteristic of the prompt context, e.g., conversation records that include n prompt rounds, conversation records that include a response of more than x characters/sentences, etc. In some implementations, the criteria may be related to a label generated for the conversation record by the answer re-write refiner 340 and/or the factual accuracy refiner 330. For example, a conversation record identified as “inaccurate” by the factual accuracy refiner 330 may become a seed conversation for the query refiner 320.

The query refiner 320 can use a query refinement user interface 310a of the user interfaces 310. The query refinement user interface 310a may be configured to provide the prompt from a seed conversation and a query generated (e.g., by the query generator 240) for the prompt. In some implementations, the query refinement user interface 310a may be configured to provide (display) the prompt context (e.g., prior prompts and responses). In some implementations, the prompt may be a denormalized prompt. The query refinement user interface 310a may be configured to receive a relevancy indicator from the user, the relevancy indicator being an indication of whether or not the query is relevant to the prompt. If the query refiner 320 determines, from the relevancy indicator, that the query is not relevant to the prompt, the query refiner 320 can mark the seed conversation as a negative training example. In other words, the training example may be used to train the query generator 240 not to predict/generate the query given the prompt context. In some implementations, the query refinement user interface 310a may be configured to request a rewrite of the query if the relevancy indicator indicates that the query is not relevant. In such an implementation, the query refinement user interface 310a may obtain a rewritten query from the user. The query refiner 320 pairs the rewritten query with the prompt context of the seed conversation to generate a new positive training example for the query generator 240. The positive training example is used to teach the query generator 240 that the rewritten query is appropriate for the prompt context. The training examples (the positive and/or negative training examples) are the training data 350 provided to the factually-grounded generative system 130, which uses the training data 350 to train the query generator 240.

The query refinement user interface 310a may be configured to receive an assumption indication from the user, the assumption indication being an indication of whether or not the query assumes a fact that is not present in the prompt. For example, a prompt may be “when was Pet Sounds released?” and a generated query of “what year did the Beatles release Pet Sounds?” includes an assumption that the Beatles released Pet Sounds. As assumption made in the query may or may not be correct (the assumption above is not correct). If the query refiner 320 determines, from the assumption indication, that the query assumes a fact not in the prompt, the query refiner 320 may mark the seed conversation as a negative training example. In some implementations, the query refinement user interface 310a may be configured to request a rewrite of the query if the assumption indication indicates that the query assumes a fact that is not present in the prompt. In such an implementation, the query refinement user interface 310a may obtain a rewritten query from the user. The query refiner 320 pairs the rewritten query with the prompt context of the seed conversation to generate a new positive training example for the query generator 240. The training examples (the positive and/or negative training examples) are the training data 350 provided to the factually-grounded generative system 130, which uses the training data 350 to train the query generator 240.

The query refinement user interface 310a may be configured to receive an answer indication from the user, the answer indication being an indication of whether or not the query directly answers an information need of the prompt. A query that directly answers the information need can include a query that requests tangential information. For example, a generated query of “songs in Pet Sounds” or “the singer of pet sounds” may request tangential information for a prompt of “when was pet sounds album released”. If the query refiner 320 determines, from the answer indication, that the query does not answer an information need of the prompt, the query refiner 320 may mark the seed conversation as a negative training example. In some implementations, the query refinement user interface 310a may be configured to request a rewrite of the query if the answer indication indicates that the query does not answer an information need of the prompt. In such an implementation, the query refinement user interface 310a may obtain a rewritten query from the user. The query refiner 320 pairs the rewritten query with the prompt context of the seed conversation to generate a new positive training example for the query generator 240. The training examples (the positive and/or negative training examples) are the training data 350 provided to the factually-grounded generative system 130, which uses the training data 350 to train the query generator 240.

In some implementations, the query refinement user interface 310a may be configured to receive a non-factual indication for the prompt, the non-factual indication being an indication of whether or not the prompt includes a fact. A prompt that mentions an entity (person, place, date, thing, etc.) does include a fact, because entity attributes are facts and the response 255 generated for the fact could get entity attributes incorrect. The query refiner 320 may use the non-factual indication to generate negative training examples for the training data 350. The negative training data represents training examples that teach the large language model 230 when/how not to rely on the context passages 245. As an example, the response generator 250 does not need to rely on the context passages 245 for a prompt that does not include a fact. To help the response generator 250 learn not to rely on the provided context passages context passages 245 for such prompts, the query refiner 320 may use the query refinement user interface 310a to identify seed conversations 131 where the prompt does not include a fact. In some implementations, the query refiner 320 may use a machine learned classifier to identify seed conversations 131 (e.g., from the model logs 270) that include a non-factual prompt. For conversation records in the model logs 270 having a prompt (current prompt) that does not include a fact, the query refiner 320 may create several negative training examples by obtaining different queries for the prompt and obtaining respective context passages 245 for each query. In some implementations, the query refiner 320 may use a query generator to obtain the queries. In some implementations, the query refiner 320 may use the query generator 240 portion of the large language model 230 to obtain the queries. In some implementations, the query refiner 320 may use a query writing interface of the user interfaces 310 to obtain the queries for the prompt. The query writing interface may present the prompt to a user and ask the user for five different queries that could be related to the prompt. The query refiner 320 may pair each query and its respective context passages 245 with the prompt context and generated response of the conversation record to create a negative training example. Because the generated response is the same for each negative training example for the prompt, the negative training examples can help teach the response generator 250 when not to rely on the context passages 245. The query refiner 320 may be configured to generate training examples to refine the query generator 240 portion of the large language model 230.

In some implementations, the query refiner 320 may use query refinements obtained from users and train a model to perform the query refinements. For example, the model can use the positive and negative training examples to learn how to generate additional training examples. For example, the model can receive the same inputs as those provided in the query refinement user interface 310a and learn to provide the same outputs that users provided via the user interface 310a. For example, a query refinement model may predict a relevancy indicator, to predict an assumption indication, to predict an answer indication, and/or to predict a non-factual indication. The advantage of using the positive and negative training examples to train a query refinement model is that the model can analyze millions of queries in a day, greatly increasing the number of training examples.

The refinement system 150 may also include factual accuracy refiner 330. The factual accuracy refiner 330 may be configured to use the model logs 270 to identify seed conversations 131. As discussed with regard to the query refiner 320, the seed conversations 131 can be conversation records from the model logs 270. The seed conversations 131 can be from public benchmarks, synthetic data generated by LLM, dialog inpainting, etc. The seed conversations 131 can be scraped from a website, such as a question-answer website, The seed conversations 131 may meet some criteria. The criteria used by the factual accuracy refiner 330 may differ from the criteria used by the query refiner 320 to identify seed conversations. The criteria may be that a prompt is categorized as a particular question type (e.g., simple question, complex question that requires multiple-hop searches, opinion questions, a question that includes a particular entity, etc.). In some implementations, the criteria may be a conversation record in the model logs 270 flagged by a user (e.g., a user participating in the conversation flags the conversation as needing further review). The criteria for the factual accuracy refiner 330 can include a random sample of conversation records from the model logs 270 where the prompt is categorized as a particular question type. If a seed conversation 131 does not have a generated response the factual accuracy refiner 330 may obtain a generated response for the prompt. The obtained generated response becomes part of the seed conversation. The generated response can be from a large language model. The generated response can be obtained from a user (e.g., via one of the user interfaces 310).

The factual accuracy refiner 330 can use a factual accuracy user interface 310b of the user interfaces 310. The factual accuracy user interface 310b may be configured to provide (display) the prompt from a seed conversation and the response generated for the prompt to a number n of users. In other words, the factual accuracy refiner 330 uses the factual accuracy user interface 310b to obtain factual accuracy ratings from n users for each seed conversation. The number n may be an odd number, which can help with determining the factual accuracy label for a seed conversation. The number of users may be five users. In some implementations, the prompt may be a denormalized prompt. The factual accuracy user interface 310b may be configured to display the prompt context (e.g., prior prompt rounds) and the response generated for the current prompt. The factual accuracy user interface 310b may be configured to obtain a factual rating based on a rating scale. The rating scale may have an odd number of ratings. A highest rating of the rating scale may indicate the generated response is completely accurate. A lowest rating of the rating scale may be a not confident rating (indicating that the user is not sure if the generated response is accurate). A second lowest rating of the rating scale may indicate the generated response is inaccurate. Implementations may include other indications of accuracy in between completely accurate and inaccurate. In an example implementation, the rating scale may be a five-point scale. The midpoint of the five-point rating scale may indicate the generated response is questionably accurate. A second highest rating of a five-point rating scale may indicate the generated response is reasonably accurate.

The query refinement user interface 310a may be configured to receive a factual accuracy rating for each of the n users for the seed conversation. Because completely accurate is more likely to be rated wrong while inaccurate is more likely to be rated correctly, the factual accuracy refiner 330 may aggregate the n factual accuracy ratings to generate a training label for the seed conversation. The training label may be one of the values of the rating scale. The factual accuracy refiner 330 may count the number of the n uses that gave the generated response of the seed conversation a threshold rating. In some implementations, the threshold rating can be the midpoint of the rating scale. In such an implementation the training label represents a partially accurate rate or PAR. In the example of the five-point scale, the threshold rating may represent a questionably relevant response for the prompt/prompt context. In some implementations, the threshold rating can be a highest rating of the rating scale. In some implementations, the threshold rating can be expressed as in a high percentile of the scale. For example, the threshold rating may represent the 80th percentile, the 90th percentile, the 95th percentile, etc. In an example of a five-point rating scale, the threshold rating may be the second-highest rating (e.g., the 80th percentile). In such implementations, either a rating of completely accurate or reasonably accurate would meet the threshold rating. Such implementations the training label represents a completely accurate rate or CAR.

The factual accuracy refiner 330 may determine the training label for the seed conversation according to the count of ratings that meet the threshold rating and a lowest rating of the n ratings for a seed conversation. In an example with five users (n=5) a five-point rating scale, the five values may represent completely accurate, reasonably accurate, questionably accurate, inaccurate, and not confident. Accurate may be considered a highest rating of the rating scale and not confident a lowest rating of the rating scale. In this example, the factual accuracy refiner 330 may determine whether at most one rating is below the threshold rating. If at most one rating is below the threshold rating, the factual accuracy refiner 330 may assign the seed conversation an accurate label. In some implementations, the factual accuracy refiner 330 may assign the accurate label only if it determines that none of the ratings are below the threshold ratings. If the factual accuracy refiner 330 does not assign the seed conversation an accurate label, the factual accuracy refiner 330 determines whether at least one rating is an inaccurate rating and, if so, whether the count is at least a threshold count. The threshold count may be two (e.g., at least two users rated the response of the seed conversation at the threshold rating). If the count is at least a threshold count and at least one rating for the seed conversation is an inaccurate rating, the factual accuracy refiner 330 may assign the seed conversation an inaccurate label.

If not already assigned a label, the factual accuracy refiner 330 may determine whether or not at least one rating is a questionably accurate rating and, if at least one rating is a questionably accurate rating, whether the count is at least the threshold count. If the factual accuracy refiner 330 determines that at least one rating is a questionably accurate rating and the count is at least the threshold count, the factual accuracy refiner 330 provides a label of questionably accurate for the seed conversation.

If not already assigned a label, the factual accuracy refiner 330 may determine whether or not at least one rating is reasonably accurate and the count is at least the threshold count. If the factual accuracy refiner 330 determines that at least one rating is a reasonably accurate rating and the count is at least the threshold count, the factual accuracy refiner 330 provides a label of reasonably accurate to the seed conversation. If not already assigned a label, the factual accuracy refiner 330 provides a label of not confident. In other words, in response to failing to provide another label the factual accuracy refiner 330 assigns a label of not confident to the seed conversation.

The factual accuracy refiner 330 may pair the training label with the seed conversation to generate a new training example for the training data for the response generator 250.

The refinement system 150 may also include answer re-write refiner 340. The answer re-write refiner 340 may be configured to use the model logs 270 to identify seed conversations 131, as discussed with regard to the factual accuracy refiner 330. In some implementations, the answer re-write refiner 340 may use seed conversations labeled as not confident by the factual accuracy refiner 330 as seed conversations. In some implementations, the answer re-write refiner 340 may use seed conversations labeled as not confident or inaccurate by the factual accuracy refiner 330 as seed conversations. In some implementations, the answer re-write refiner 340 may use seed conversations labeled as not confident or inaccurate or questionably accurate by the factual accuracy refiner 330 as seed conversations.

The answer re-write refiner 340 can use a re-write user interface 310c of the user interfaces 310 to generate training examples. The re-write user interface 310c may be configured to display the prompt, the generated response, and multiple search snippets. A search snippet is a resource and content extracted from the resource. The search results returned by the search system (e.g., supporting resources 127) are examples of search snippets. The re-write user interface 310c may request that the user rewrite the response if the response is contracted by one of the search snippets. The re-write user interface 310c may request that the user rewrite the response if the response is contradicted by the user's knowledge. To enhance the user's knowledge, the re-write user interface 310c may include access to a search engine so that the user can perform Internet searches. In some implementations, the re-write user interface 310c may obtain an indication from the user that the response cannot be contradicted by a fact (e.g., that the response does not include a factual assertion). Such an indication may be used to generate training examples to learn when not to use search results, as described above with regard to the query refiner 320. In some implementations, the re-write user interface 310c may include an instruction to the user not to rewrite a response when the prompt includes a timely fact. For example, if the prompt of the seed conversation is “what is the current weather” the re-write user interface 310c may instruct the user to skip rewriting the response if none of the search snippets include information that supports the facts in the response. This is to avoid training the large language model 230 to memorize a response for prompts that include timely facts. The answer re-write refiner 340 may pair the training label with the seed conversation to generate a new training example for the training data for the response generator 250.

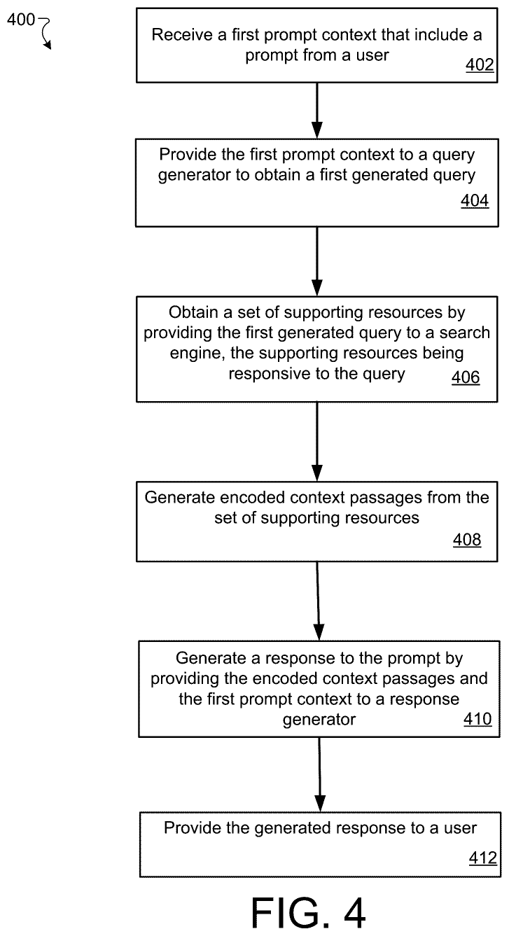

In some implementations, the answer re-write refiner 340 may use rewritten responses obtained from users and train a model to provide rewritten answers. For example, the model can use the training examples obtained from the re-write user interface 310c to learn how to generate additional training examples. For example, the model can receive the same inputs as those provided in the re-write user interface 310c (e.g., the prompt, the generated response, and multiple search snippets), an indication of whether the user indicated the response was correct (needed no rewrite), an indication that the response could not be contradicted, or the rewritten response. The model, e.g., an answer re-write model, can be trained to provide a rewritten response, an indication that the response is correct, or an indication that the response cannot be contradicted given a prompt, generated response, and snippets. The advantage of using the human-rated examples from the re-write user interface 310c to train an answer re-write model is that the model can analyze millions of queries in a day, greatly increasing the number of training examples. FIG. 4 is a diagram that illustrates an example method 400 for providing factually-grounded generative responses, according to disclosed implementations. Method 400 may be executed in an environment, such as environment 100. In some implementations, one or more of the method steps may be executed by a system, such as factually-grounded generative system 130 of FIG. 1. At step 402, the system receives a first prompt context. The first prompt context includes a prompt received from a user. The prompt may also be referred to as a current prompt. The first prompt context can include prior prompts and prior generated responses in a conversation (session), if such prior prompts exist. At step 404 the system provides the first prompt context to a query generator and obtains a first generated query from the query generator. The query generator may be a first portion of a large language model that includes the query generator and a response generator. The query generator may be a model that predicts a query given a prompt context. At step 406, the system obtains a set of supporting resources by providing the first generated query to a search engine. The supporting resources are documents identified by the search engine as responsive to the first generated query. At step 408 the system generates encoded context passages from the set of supporting resources. The encoded context passages may be medium-length relevant text from the set of supporting resources. The encoded context passages may include at least two different relevant passages from the set of supporting resources. The encoded context passages may include one to three relevant passages from the set of supporting resources, depending on a relevance score for the passages. The relevance of a passage is based on the first query. The encoded context passages may be a concatenation of the relevant passages. At step 410 the system generates a response to the first prompt context by providing the first plurality of encoded context passages and the first prompt context to a response generator. The response generator may be a large language model. The response generator may be a response generating portion of a large language model. At step 412 the system provides the generated response to the user.

In some implementations, the generated response may be provided with corroborating resources. A corroboration resource is a resource that corroborates a fact identified in the generated response. As one example, the system may determine that the prompt relates to a fact; and provide the generated query with the response for presentation to the user. This query can be provided as a suggested search. The suggestion can be a selectable control with a title such as “check response”. As another example, the system may determine that a span of text in the generated response includes a fact and identify one or more corroborating resources for the fact. A corroborating resource is any resource that includes content that supports the fact; A corroborating resource may be identified from the set of supporting resources. A corroborating resource may be identified in response to the span of text being submitted to a search engine. In some implementations, the system may alter an appearance of the span. In some implementations, the system may provide a control that, when selected, navigates to the supporting resource. The control can be a favicon for the corroborating resource. The control can be a hyperlink having a footnote as anchor text. The control can be a hyperlink having the span as anchor text.

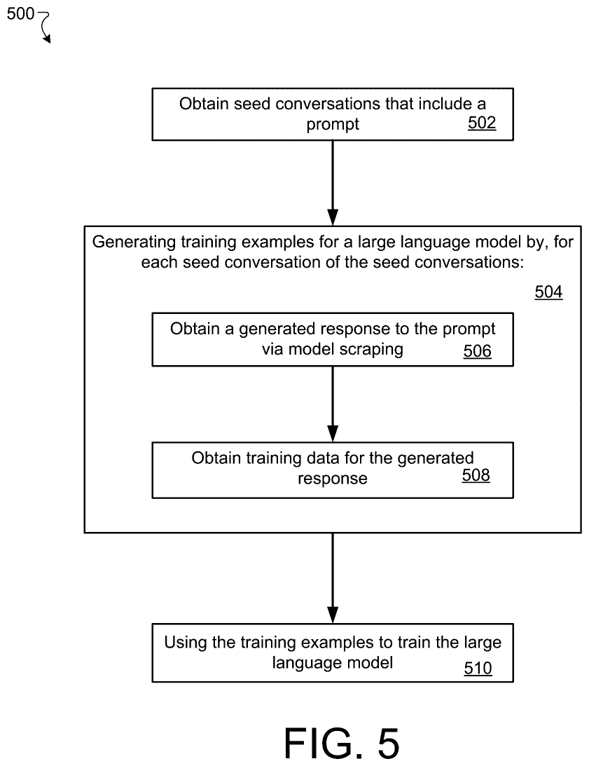

FIG. 5 is a diagram that illustrates an example method 500 for refining a large language model, according to disclosed implementations. The method 500 may be executed in an environment, such as environment 100. In some implementations, one or more of the method steps may be executed by a system, such as factually-grounded generative system 130 of FIG. 1. While illustrated in FIG. 5 as training a large language model to generate a response, implementations also apply to training a model (including a large language model) to generate a query. At step 502, the system obtains seed conversations. In some implementations, the seed conversations can include a prompt. The prompt can be a question. The prompt can be a statement. The prompt can include at least one entity. In some implementations, the seed conversations can include a prompt and a response. The seed conversations can include a prompt that satisfies a criteria. The seed conversations can include a generated response that satisfies a criteria. In some implementations, the seed conversations can be scraped from a website, such as a wiki site, a question-and-answer site, etc. In some implementations, the seed conversations can be obtained from a model log. The model log can include conversation records. A conversation record includes a prior prompt context and a response generated for the prompt context. The conversation record can include a query or queries generated for the prompt context. The conversation record can include responsive sections of supporting resources, which are resources identified by a search engine as responsive to the query (or queries).

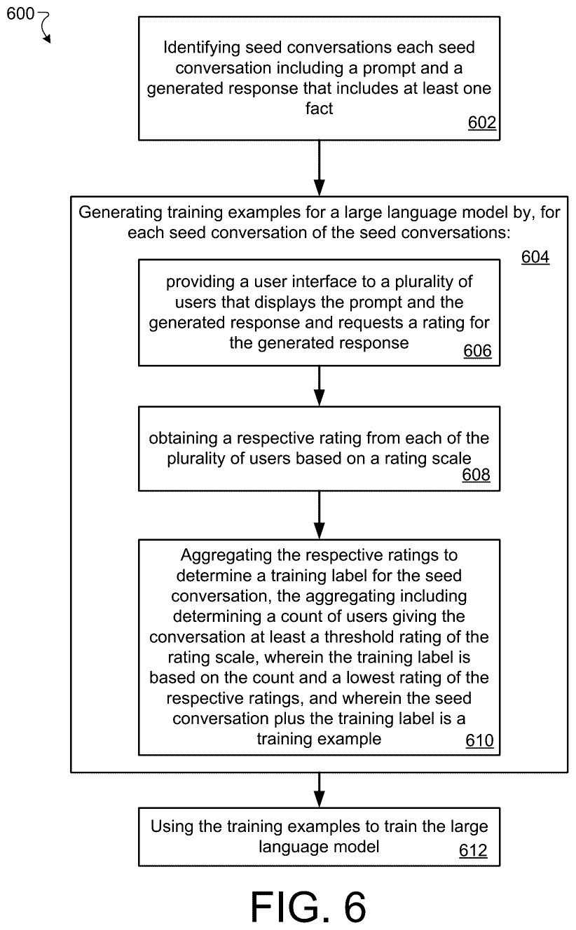

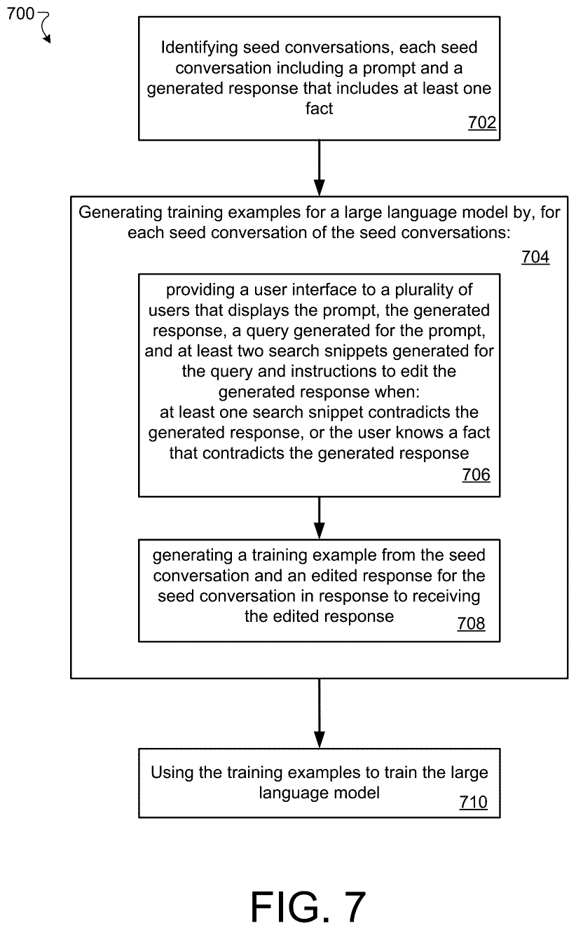

At step 504, the system generates training examples for a large language model from the seed conversations. Steps 506 and/or 508 may be repeated for each seed conversation. At step 506, if the seed conversation does not already have a generated response (or a generated query), the system may obtain a generated response to (or query for) the prompt. In some implementations, the response may be obtained via model scraping. In model scraping, a large language model may be asked to provide a response (or a query) for a particular prompt. In some implementations, the response (or query) may be obtained from a user. For example, a user may be asked to provide a three to five sentence response to the query. As another example, a user may be asked to provide a search query that answers a particular prompt. Step 506 may be optional for seed conversations that already have a generated response (or query). At step 508 the system may obtain training data for the generated response (or query. The training data may be obtained as described with respect to FIG. 3 and/or FIGS. 6 and 7. At step 510 the system uses the training examples to train (refine, fine-tune) the large language model. Method 500 may be repeated as needed to fine-tune the model on different types of prompts, different types (categories) of questions, etc.

FIG. 6 is a diagram that illustrates an example method 600 for refining a generative model, according to disclosed implementations. The method 600 may be executed in an environment, such as environment 100. In some implementations, one or more of the method steps may be executed by a system, such as factually-grounded generative system 130 and/or refinement system 150 of FIG. 1. At step 602, the system obtains seed conversations. The seed conversations can include a prompt and a generated response. The prompt can be a question. The prompt can be a statement. The prompt can include at least one entity. The seed conversations can include a prompt that satisfies a criterion. The seed conversations can include a generated response that satisfies a criterion. In some implementations, the seed conversations can be scraped from a website, such as a wiki site, a question-and-answer site, etc. In some implementations, the seed conversations can be obtained from a model log. The model log can include conversation records. A conversation record includes a prior prompt context and a response generated for the prompt context. The conversation record can include a query or queries generated for the prompt context. The conversation record can include responsive sections of supporting resources, which are resources identified by a search engine as responsive to the query (or queries). In some implementations, the system may obtain a response for a prompt as part of step 602, e.g., using model scraping or a user interface.

At step 604, the system generates training examples for a large language model from the seed conversations. Steps 606 to 610 may be repeated for each seed conversation. At step 606, the system may provide a user interface to a plurality of users, e.g., to n users, where n is the number of users. N may be an odd number so that there can be a majority of votes for a particular rating. The user interface may be configured to display the prompt and the generated response and to request a rating for the generated response. The rating may be a value on a rating scale. At step 608 the system may obtain a respective rating from each of the n (plurality) of users based on the rating scale. At step 610 the system may aggregate the respective ratings to determine a training label for the seed conversation. The aggregating can include determining a count of users giving the conversation at least a threshold rating of the rating scale. The threshold rating can be a highest rating. The threshold rating can be a second-highest rating. The threshold rating can be a rating that represents a midpoint on the rating scale. The training label may be based on the count and a lowest rating of the respective ratings. The training label may represent a value on the rating scale. The system may generate a training example for the seed conversation that includes the seed conversation plus the training label. At step 612 the system uses at least some of the training examples to train the large language model. Method 600 can be repeated as needed, e.g., using different criteria to identify the seed conversations.

FIG. 7 is a diagram that illustrates an example method 700 for refining a generative model, according to disclosed implementations. The method 700 may be executed in an environment, such as environment 100. In some implementations, one or more of the method steps may be executed by a system, such as factually-grounded generative system 130 and/or refinement system 150 of FIG. 1. At step 702, the system obtains seed conversations. The seed conversations can include a prompt and a generated response. The prompt can be a question. The prompt can be a statement. The prompt can include at least one entity. The seed conversations can include a prompt that satisfies a criterion. The seed conversations can include a generated response that satisfies a criterion. In some implementations, the seed conversations can be scraped from a website, such as a wiki site, a question-and-answer site, etc. In some implementations, the seed conversations can be obtained from a model log. The model log can include conversation records. A conversation record includes a prior prompt context and a response generated for the prompt context. The conversation record can include a query or queries generated for the prompt context. The conversation record can include responsive sections of supporting resources, which are resources identified by a search engine as responsive to the query (or queries). In some implementations, the system may obtain a response for a prompt as part of step 702, e.g., using model scraping or a user interface.

At step 704, the system generates training examples for a large language model from the seed conversations. Steps 706 to 708 may be repeated for each seed conversation. At step 706, the system may provide a user interface to a plurality of users, the user interface configured to display the prompt, the generated response, a query generated for the prompt, at least two search snippets generated for the query, and instructions to edit the generated response. The instructions may indicate to the user to edit the generated response when either at least one search snippet contradicts the generated response or the user knows a fact that contradicts the generated response. The user interface may include a search engine interface that enables the user to perform an internet search to find out whether a fact exists that contradicts the generated response. At step 708 the system generates a training example in response to the user editing a response. The training example includes the prompt from the seed conversation and the edited response. At step 710 the system trains the large language model using the training examples.

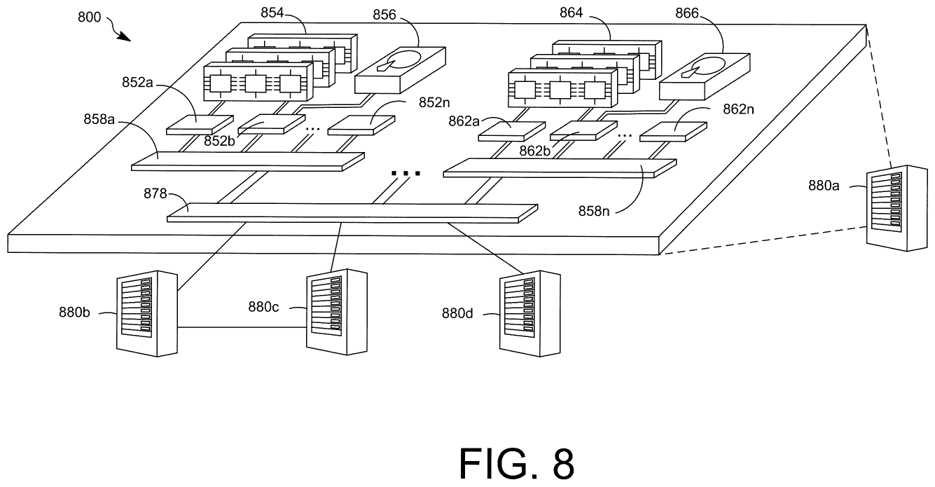

FIG. 8 shows an example of a computing device 800, which may be search system 120, the factually-grounded generative system 130, and/or the refinement system 150 of FIG. 1, which may be used with the techniques described here. Computing device 800 is intended to represent various example forms of large-scale data processing devices, such as servers, blade servers, data centers, mainframes, and other large-scale computing devices. Computing device 800 may be a distributed system having multiple processors, possibly including network attached storage nodes, that are interconnected by one or more communication networks. The components shown here, their connections and relationships, and their functions, are meant to be examples only, and are not meant to limit implementations of the inventions described and/or claimed in this document.

Computing device 800 may be a distributed system that includes any number of computing devices 880 (e.g., 880a, 880b, . . . 880n). Computing devices 880 may include a server or rack servers, mainframes, etc. communicating over a local or wide-area network, dedicated optical links, modems, bridges, routers, switches, wired or wireless networks, etc.

In some implementations, each computing device may include multiple racks. For example, computing device 880a includes multiple racks 858a-858n. Each rack may include one or more processors, such as processors 852a-852n and 862a-862n. The processors may include data processors, network attached storage devices, and other computer-controlled devices. In some implementations, one processor may operate as a master processor and control the scheduling and data distribution tasks. Processors may be interconnected through one or more rack switches 862a-862n, and one or more racks may be connected through switch 878. Switch 878 may handle communications between multiple connected computing devices 800.

Each rack may include memory, such as memory 854 and memory 864, and storage, such as 856 and 866. Storage 856 and 866 may provide mass storage and may include volatile or non-volatile storage, such as network-attached disks, floppy disks, hard disks, optical disks, tapes, flash memory or other similar solid state memory devices, or an array of devices, including devices in a storage area network or other configurations. Storage 856 or 866 may be shared between multiple processors, multiple racks, or multiple computing devices and may include a non-transitory computer-readable medium storing instructions executable by one or more of the processors. Memory 854 and 864 may include, e.g., volatile memory unit or units, a non-volatile memory unit or units, and/or other forms of non-transitory computer-readable media, such as a magnetic or optical disks, flash memory, cache, Random Access Memory (RAM), Read Only Memory (ROM), and combinations thereof. Memory, such as memory 854 may also be shared between processors 852a-852n. Data structures, such as an index, may be stored, for example, across storage 856 and memory 854. Computing device 800 may include other components not shown, such as controllers, buses, input/output devices, communications modules, etc.

An entire system may be made up of multiple computing devices 800 communicating with each other. For example, device 880a may communicate with devices 880b, 880c, and 880d, and these may collectively be known as factually-grounded generative system 130, refinement system 150, and/or search system 120. Some of the computing devices may be located geographically close to each other, and others may be located geographically distant. The layout of computing device 800 is an example only and the system may take on other layouts or configurations.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

It will also be understood that when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application may be amended to recite example relationships described in the specification or shown in the figures.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Clause 1. A system comprising: a processor; a large language model configured to generate a response to a prompt context, the large language model including a query generating portion and a response generating portion, the query generating portion receiving the prompt context as input and providing a generated query as output and the response generating portion receiving the prompt context and a plurality of encoded context passages as input and providing a generated response as output, wherein the response generating portion is trained to determine whether or not to use the plurality of encoded context passages; and memory storing instructions that, when executed by the processor, cause the system to: receive a first prompt context, the first prompt context including a prompt from a user, receive a first generated query by providing the first prompt context to the query generating portion, receive a set of supporting resources by providing the first generated query to a search engine, the set of supporting resources being documents identified as responsive to the first generated query, generate a first plurality of encoded context passages based on the set of supporting resources, generate a first response to the first prompt context by providing the first plurality of encoded context passages and the first prompt context to the response generating portion, and provide the first response for presentation to the user.

Clause 2. The system as in clause 1, wherein the plurality of encoded context passages include, for each supporting resource, text selected by the search engine from content of the supporting resource.

Clause 3. The system as in clause 1 or clause 2, the memory further including instructions that cause the system to: for each supporting resource in the set of supporting resources: identify at least two relevant portions of content, and concatenate the at least two relevant portions into a context passage for the supporting resource, wherein the first encoded context passages are generated from the context passages for the set of supporting resources.

Clause 4. The system as in clause 3, wherein a relevant portion of the at least two relevant portions has a length that is longer than text selected by the search engine from the content of the supporting resource.

Clause 5. The system as in clause 4, wherein the length is less than 2000 characters.

Clause 6. The system as in any of clause 1 through clause 5, the memory further including instructions that cause the system to: for each supporting resource in the set of supporting resources, identify a relevant portion of content of the supporting resource, the relevant portion having a length longer than text selected by the search engine for the supporting resource, wherein the first encoded context passages are generated from the relevant portions for the set of supporting resources.

Clause 7. The system as in clause 6, the memory further including instructions that cause the system to, for at least one supporting resource of the set of supporting resources: identify two relevant portions of content of the supporting resource, each relevant portion having a length longer than text selected by the search engine for the supporting resource; and concatenate the two relevant portions to form a context passage, the context passage being used to generate the encoded context passages.

Clause 8. The system as in any of clause 1 through clause 7, the memory further including that cause the system to: determine that the prompt relates to a fact; and provide the first generated query with the first response for presentation to the user.

Clause 9. The system as in any of clause 1 through clause 8, the memory further including that cause the system to: determine that a span of text in the generated response includes a fact; identify, from the set of supporting resources, content in a supporting resource that supports the fact; alter an appearance of the span; and provide a control that, when selected, navigates to the supporting resource.

Clause 10. The system as in clause 9, wherein the control is one of a favicon for the supporting resource or a hyperlink having the span as anchor text.

Clause 11. The system as in any of clause 1 through clause 8, the memory further including instructions that cause the system to: determine that a span of text in the generated response includes a fact; identify, from the set of supporting resources, content in a supporting resource that supports the fact; and provide a control that, when selected, navigates to the supporting resource.

Clause 12. The system as in any of clause 1 through 8, the memory further including that cause the system to: determine that a span of text in the generated response includes a fact; and add a hyperlink to the span, the hyperlink configured to submit the span of text as a query to the search engine.

Clause 13. The system as in any of clause 1 through 8, the memory further including instructions that cause the system to: determine that a span of text in the generated response includes a fact; submit the span of text as a query to the search engine; alter an appearance of the span; and provide a control that, when selected, navigates to a top-ranked search result identified by the search engine as responsive to the query.

Clause 14. A method comprising: identifying seed conversations, each seed conversation including a prompt and a generated response that includes at least one fact; generating training examples for a large language model by, for each seed conversation of the seed conversations: providing a user interface to a plurality of users that displays the prompt and the generated response and requests a rating for the generated response, obtaining a respective rating from each of the plurality of users based on a rating scale, and aggregating the respective ratings to determine a training label for the seed conversation, the aggregating including determining a count of users giving the seed conversation at least a threshold rating of the rating scale, wherein the training label is based on the count and a lowest rating of the respective ratings, and wherein the seed conversation plus the training label is a training example; and using the training examples to train the large language model.

Clause 15. The method as in clause 14, wherein the rating scale has an odd number of ratings and the threshold rating is a midpoint of the rating scale.

Clause 16. The method as in clause 14 or clause 15, wherein the threshold rating represents at least an 80th percentile of the rating scale.

Clause 17. The method as in clause 14 or clause 15, wherein the threshold rating represents a highest rating of the rating scale.

Clause 18. The method as in any of clauses 15 to 17, wherein the rating scale is a five-point scale representing values for completely accurate, reasonably accurate, questionably accurate, inaccurate, and not confident, wherein accurate is considered a highest rating of the rating scale and determining a training label includes: providing a label of accurate in response to determining at most one respective rating is below the threshold rating; providing a label of inaccurate in response to determining at least one rating is an inaccurate rating and the count is at least a threshold count; providing a label of questionably accurate in response to determining at least one rating is a questionably accurate rating and the count is at least the threshold count; providing a label of reasonably accurate in response to determining at least one rating is reasonably accurate and the count is at least the threshold count; and providing a label of not confident in response to failing to provide another label.

Clause 19. The method as in clause 18, further comprising providing the label of accurate in response to determining no respective rating is below the threshold rating.

Clause 20. A method comprising: identifying seed conversations, each seed conversation including a prompt and a generated response that includes at least one fact; generating training examples for a large language model by, for each seed conversation of the seed conversations: providing a user interface to a plurality of users that displays the prompt, the generated response, a query generated for the prompt, and at least two search snippets generated for the query and instructions to edit the generated response when: at least one search snippet contradicts the generated response, or a fact that contradicts the generated response is known by a user, wherein a training example is a seed conversation and an edited response for the seed conversation; and using the training examples to train the large language model.

Clause 21. The method as in clause 20, the user interface further comprising a control for indicating the generated response does not include a factual statement, wherein the training examples includes an indication of whether the generated response includes a factual statement.

Clause 22. The method as in clause 20, the user interface further comprising a control for rewriting the query, and the method further includes: obtaining a rewritten query in response to selection of the control, wherein the rewritten query is included in the training example.

Clause 23. The method as in clause 20, the user interface instructs a user to skip the editing when the generated response includes a timely fact.

Clause 24. A method comprising: receiving a prompt context, the prompt context including a prompt from a user, obtaining a first query from a query generating portion of a large language model, the query generating portion using the prompt context as input; receiving a set of supporting resources by providing the first query to a search engine, the set of supporting resources being documents identified as responsive to the first query; generating a response to the prompt context by providing relevant content from the set of supporting resources and the prompt context to a response generating portion of the large language model; determining that a span of text in the generated response includes a fact; submitting the span of text as a second query to the search engine; and providing the response and a control that, when selected, navigates to a top-ranked search result identified by the search engine as responsive to the second query for presentation to the user.

Clause 25. A method comprising: receiving a prompt context, the prompt context including a prompt from a user, obtaining a query from a query generating portion of a large language model, the query generating portion using the prompt context as input; receiving a set of supporting resources by providing the query to a search engine, the set of supporting resources being documents identified as responsive to the query; generating a response to the prompt context by providing relevant content from the set of supporting resources and the prompt context to a response generating portion of the large language model; determining that a span of text in the generated response includes a fact; adding a hyperlink to the span, the hyperlink configured to submit the span of text as a query to the search engine; and providing the response for presentation to the user.

Clause 26. A method comprising: receiving a prompt context, the prompt context including a prompt from a user; obtaining a query from a query generating portion of a large language model, the query generating portion using the prompt context as input; receiving a set of supporting resources by providing the query to a search engine, the set of supporting resources being documents identified as responsive to the query; generating a response to the prompt context by providing relevant content from the set of supporting resources and the prompt context to a response generating portion of the large language model; determining that a span of text in the generated response includes a fact; adding a hyperlink to the span, the hyperlink configured to submit the span of text as a query to the search engine; and providing the response for presentation to the user.

Clause 27: A system comprising: at least one processor and memory storing instructions that, when executed by the at least one processor, causes the system to perform any of the methods of clauses 14 through 26.

What is claimed is:

1. A system comprising:
a processor;
a large language model configured to generate a response to a prompt context, the large language model including a query generating portion and a response generating portion, the query generating portion receiving the prompt context as input and providing a generated query as output and the response generating portion receiving the prompt context and a plurality of encoded context passages as input and providing a generated response as output, wherein the response generating portion is trained to determine whether or not to use the plurality of encoded context passages; and
memory storing instructions that, when executed by the processor, cause the system to:
receive a first prompt context, the first prompt context including a prompt from a user,
receive a first generated query by providing the first prompt context to the query generating portion,
receive a set of supporting resources by providing the first generated query to a search engine, the set of supporting resources being documents identified as responsive to the first generated query,
generate a first plurality of encoded context passages based on the set of supporting resources,
generate a first response to the first prompt context by providing the first plurality of encoded context passages and the first prompt context to the response generating portion, and
provide the first response for presentation to the user.

2. The system as in claim 1, wherein the plurality of encoded context passages include, for each supporting resource, text selected by the search engine from content of the supporting resource.

3. The system as in claim 1, the memory further including instructions that cause the system to:
for each supporting resource in the set of supporting resources:
identify at least two relevant portions of content, and
concatenate the at least two relevant portions into a context passage for the supporting resource,
wherein the first encoded context passages are generated from the context passages for the set of supporting resources.

4. The system as in claim 3, wherein a relevant portion of the at least two relevant portions has a length that is longer than text selected by the search engine from the content of the supporting resource.

5. The system as in claim 4, wherein the length is less than 2000 characters.

6. The system as in claim 1, the memory further including instructions that cause the system to:
for each supporting resource in the set of supporting resources, identify a relevant portion of content of the supporting resource, the relevant portion having a length longer than text selected by the search engine for the supporting resource,
wherein the first encoded context passages are generated from the relevant portions for the set of supporting resources.

7. The system as in claim 6, the memory further including instructions that cause the system to, for at least one supporting resource of the set of supporting resources:
identify two relevant portions of content of the supporting resource, each relevant portion having a length longer than text selected by the search engine for the supporting resource; and
concatenate the two relevant portions to form a context passage, the context passage being used to generate the encoded context passages.

8. The system as in claim 1, the memory further including that cause the system to:
determine that the prompt relates to a fact; and
provide the first generated query with the first response for presentation to the user.

9. The system as in claim 1, the memory further including that cause the system to:
determine that a span of text in the generated response includes a fact;
identify, from the set of supporting resources, content in a supporting resource that supports the fact;
alter an appearance of the span; and
provide a control that, when selected, navigates to the supporting resource.

10. The system as in claim 9, wherein the control is one of a favicon for the supporting resource or a hyperlink having the span as anchor text.

11. The system as in claim 1, the memory further including instructions that cause the system to:
determine that a span of text in the generated response includes a fact;
identify, from the set of supporting resources, content in a supporting resource that supports the fact; and
provide a control that, when selected, navigates to the supporting resource.

12. The system as in claim 1, the memory further including that cause the system to:
determine that a span of text in the generated response includes a fact; and
add a hyperlink to the span, the hyperlink configured to submit the span of text as a query to the search engine.

13. The system as in claim 1, the memory further including instructions that cause the system to:
determine that a span of text in the generated response includes a fact;
submit the span of text as a query to the search engine;
alter an appearance of the span; and
provide a control that, when selected, navigates to a top-ranked search result identified by the search engine as responsive to the query.

14. A method comprising:
identifying seed conversations, each seed conversation including a prompt and a generated response that includes at least one fact;
generating training examples for a large language model by, for each seed conversation of the seed conversations:
providing a user interface to a plurality of users that displays the prompt and the generated response and requests a rating for the generated response,
obtaining a respective rating from each of the plurality of users based on a rating scale, and
aggregating the respective ratings to determine a training label for the seed conversation, the aggregating including determining a count of users giving the seed conversation at least a threshold rating of the rating scale, wherein the training label is based on the count and a lowest rating of the respective ratings, and wherein the seed conversation plus the training label is a training example; and
using the training examples to train the large language model.

15. The method as in claim 14, wherein the rating scale has an odd number of ratings and the threshold rating is a midpoint of the rating scale.

16. The method as in claim 14, wherein the threshold rating represents at least an 80^{th} percentile of the rating scale.

17. The method as in claim 14, wherein the threshold rating represents a highest rating of the rating scale.

18. The method as in claim 14, wherein the rating scale is a five-point scale representing values for completely accurate, reasonably accurate, questionably accurate, inaccurate, and not confident, wherein accurate is considered a highest rating of the rating scale and determining a training label includes:
providing a label of accurate in response to determining at most one respective rating is below the threshold rating;
providing a label of inaccurate in response to determining at least one rating is an inaccurate rating and the count is at least a threshold count;
providing a label of questionably accurate in response to determining at least one rating is a questionably accurate rating and the count is at least the threshold count;
providing a label of reasonably accurate in response to determining at least one rating is reasonably accurate and the count is at least the threshold count; and
providing a label of not confident in response to failing to provide another label.

19. The method as in claim 18, further comprising providing the label of accurate in response to determining no respective rating is below the threshold rating.

20. A method comprising:
identifying seed conversations, each seed conversation including a prompt and a generated response that includes at least one fact;
generating training examples for a large language model by, for each seed conversation of the seed conversations:
providing a user interface to a plurality of users that displays the prompt, the generated response, a query generated for the prompt, and at least two search snippets generated for the query and instructions to edit the generated response when:
at least one search snippet contradicts the generated response, or a fact that contradicts the generated response is known by a user,
wherein a training example is a seed conversation and an edited response for the seed conversation; and
using the training examples to train the large language model.

21. The method as in claim 20, the user interface further comprising a control for indicating the generated response does not include a factual statement, wherein the training examples includes an indication of whether the generated response includes a factual statement.

22. The method as in claim 20, the user interface further comprising a control for rewriting the query, and the method further includes:
obtaining a rewritten query in response to selection of the control,
wherein the rewritten query is included in the training example.

23. The method as in claim 20, the user interface instructs a user to skip the editing when the generated response includes a timely fact.

24. The method as in claim 20, further comprising:
using the training examples to train an answer re-write model to provide rewritten responses;
identifying additional seed conversations;
using the answer re-write model to generate additional training examples from the additional seed conversations; and
using the additional training examples to train the large language model.

25. A method comprising:
receiving a prompt context, the prompt context including a prompt from a user,
obtaining a first query from a query generating portion of a large language model, the query generating portion using the prompt context as input;
receiving a set of supporting resources by providing the first query to a search engine,
the set of supporting resources being documents identified as responsive to the first query;
generating a response to the prompt context by providing relevant content from the set of supporting resources and the prompt context to a response generating portion of the large language model;
determining that a span of text in the generated response includes a fact;
submitting the span of text as a second query to the search engine; and
providing the response and a control that, when selected, navigates to a top-ranked search result identified by the search engine as responsive to the second query for presentation to the user.

26. A method comprising:
receiving a prompt context, the prompt context including a prompt from a user,
obtaining a query from a query generating portion of a large language model, the query generating portion using the prompt context as input;
receiving a set of supporting resources by providing the query to a search engine, the set of supporting resources being documents identified as responsive to the query;
generating a response to the prompt context by providing relevant content from the set of supporting resources and the prompt context to a response generating portion of the large language model;
determining that a span of text in the generated response includes a fact;
adding a hyperlink to the span, the hyperlink configured to submit the span of text as a query to the search engine; and
providing the response for presentation to the user.
